(19) United States
(12) Patent Application Publication
(10) Pub. No.: US 2016/0259899 A1
(43) Pub. Date: Sep. 8, 2016

(54) CLINICAL DECISION SUPPORT SYSTEM FOR DIAGNOSING AND MONITORING OF A DISEASE OF A PATIENT

(71) Applicant: Expeda ehf, Kopavogur (IS)

(72) Inventors: Bjorn Runar LUDVIKSSON, Gardabaer (IS); Bjorn GUDBJORNSSON, Reykjavik (IS); Bjarni HALLDORSSON, Reykjavik (IS); Dagrun JONASDOTTIR, Reykjavik (IS)

(21) Appl. No.: 15/061,305

(22) Filed: Mar. 4, 2016

Related U.S. Application Data
(60) Provisional application No. 62/128,377, filed on Mar. 4, 2015.

(51) Int. Cl. G06F 19/00

(52) U.S. Cl. CPC G06F 19/345

(57) ABSTRACT

A clinical decision support system for diagnosis and monitoring of a disease of at least one patient includes a computing system, a storage media, in communication with the computer system, configured to store medical data sets from two or more different medical training data sources, where each of the two or more different medical training data sources have uniquely defined objective findings influencing the disease. The severity of the objective findings within each data source is indicated by independent weight factors. A computer program operating on the computing system is configured to perform a knowledge mapping between the data in the two or more different medical training data sources for obtaining plurality of clinical weight factors that define a unique classification rules. An input module is provided for receiving medical data about a patient, and a processor processes the received medical data from the input module.

### FIELD OF THE INVENTION

The present invention relates to a clinical decision support system and a method for diagnosis and monitoring of a disease of at least one patient.

### BACKGROUND OF THE INVENTION

Systemic Autoimmune diseases are a broad class of diseases that can involve all of the major organs in the body and are characterized by various and complex objective and subjective clinical findings including the production of autoantibodies that recognize a diverse array of cytoplasmic and nuclear antigens. Some of these diseases include Rheumatoid arthritis (RA), Systemic lupus erythematosus (SLE), Sjögren's Syndrome (SS) and polymyositis/dermatomyositis (PM/DM). While Diagnosis by laboratory testing may be used it is costly and results may not positively confirm nor rule out the correct diagnosis. Furthermore, these diseases are often present in one form or another without presenting with the specific disease defining symptoms that most commonly would be associated with them. Thus, creating a high demand for improved diagnostic approach, which leaves a lot to be gained in terms of early detection of these potentially life threatening conditions.

The main difficulty of modelling medical data is the complex nature of such data sets. Medical data generally don't possess a formal, mathematically defined structure into which the information involved with the data can be organized. Most unprocessed medical data sets are heterogeneous; they may be collected from images, patient interviews, laboratory data and medical expert-based interpretations of presented symptoms. In many cases, combined information from all these different sources is necessary to obtain a final diagnosis.

An additional problem widely encountered in medical data mining is the large number of missing values that is bound to accompany any larger medical data sets. Most medical data are acquired as a by-product of standard diagnostic processes and are, as such, not collected in an organized, mathematical manner. Values are also commonly omitted in medical data sets due to technical, economical or ethical reasons. Immunological blood tests are an example of this. They are known to involve labour-intensive and very costly analytical processes. Therefore, in most cases, only about a half to one third of these tests are ordered and performed, leading to a substantial loss of data. The variables that compose the sets may furthermore be hard to interpret, especially for non-experts in the field. A demand for an expert system that can model such challenging data sets, and assist medical experts in the diagnostic process for autoimmune diseases has therefore arisen. Majority of health care workers use their experience, knowledge and patient data to analyse and give their patients optimal medical care without the aid of any computerized clinical data support system. Regretfully in a world of ever increasing medical knowledge such an approach is not sufficient as it may not result in optimal care due to the complexity of many diseases.

Today's experienced medical expert needs close to 2 million pieces of information to practice modern medicine in addition to the overwhelming load of new medical knowledge published each year. However, the human capacity is a limiting factor in processing all available scientific data in order to arrive at the best intervention(s) and treatment(s). Therefore, there is a substantial risk for diagnostic errors leading to delay in correct therapeutic interventions and treatment failures for the patient. It is estimated that wrongful therapeutic interventions come second to accidental deaths in USA.

### SUMMARY OF THE INVENTION

On the above background it is an object of embodiments of the present invention to provide a fast and cost effective clinical decision support system (CDSS) that is capable of automatically diagnosis and monitoring of a disease of a patient based on input data about the patient, where the input data may e.g. include heterogeneous medical data such as objective, subjective and laboratory clinical data.

Embodiments of the invention preferably seeks to mitigate, alleviate or eliminate one or more of the above mentioned disadvantages singly or in any combination. In particular, it may be seen as an object of embodiments of the present invention to provide a clinical decision support system that solves the above mentioned problems, or other problems, of the prior art.

To address one or more of these concerns, in a first aspect of the invention a clinical decision support system is provided for diagnosis and monitoring of a disease of at least one patient, the system comprising:
a computing system,
a storage media, in communication with the computer system, configured to store medical data sets from two or more different medical training data sources, where each of the two or more different medical training data sources have uniquely defined objective findings influencing the disease, the severity of the objective findings within each data source being indicated by independent weight factors,
a computer program operating on the computing system, the computer program being configured to perform a knowledge mapping between the data in the two or more different medical training data sources, where the knowledge mapping includes:
   a) receiving a first and at least one second weight factors from a first and at least one second medical training data sources selected from the two or more different medical training data sources,
   b) determining, based on the received weight factors, at least one clinical weight factor by means of utilizing interactive rules associated to the two or more different medical training data sources, the at least one clinical weight factor indicating the severity of the combination of the first and the at least one second symptom weight factors to the disease,
   c) repeating steps a) and b) for the remaining weight factors within the two or more different medical training data sources so as to determine the remaining clinical weight factors resulting in a unique classification rules,
an input module adapted to receive medical data about a patient, and
a processor for processing the received medical data from the input module, where the processing includes:
   comparing the receive medical data to the unique classification rules, and based thereon
   extracting an appropriate personalized medical assessment indicator for the patient.

Using the first and at least one second weight factors as input data in determining the clinical weight factors via the interactive rules, which define the knowledge foundation for the clinical decision support system, it is possible to predict accurately, diagnose and monitor the disease for the patient.

The disease may as an example be, but is not limited to, Systemic Autoimmune disease and the first and at the least one second weight factors may as an example be the weight of the patient (e.g. the first weight factor), whether the patient smokes or not (e.g. the second weight factor), whether the patient is male or female (e.g. the third weight factor), symptoms from different organs such as number of joints affected by pain or swelling (e.g. the fourth weight factor). The interactive rules automatically evaluate how the clinical weight factors and thus the severity of the disease of the combination of the two or more weight factors changes, but different combinations may result in completely different results. As an example, the severity of the combination of these weight factors may be completely different if the patient is obese (e.g. above 100 kg) compared to if the patient is thin (e.g. 55 kg), or the severity may be completely different if the patient is male and not female, or if the patient has two joints affected by pain or swelling instead of one.

Accordingly, an automated and patient friendly clinical decision support system is provided that mimics the actions/measures/behaviour that a medical expert would undertake during his medical work up process. The system may e.g. be utilized by the patient with a potential underlying disease himself, where the personalized medical assessment indicator may e.g. indicate to the patient whether the patient needs a medical help or not and/or critical clinical recommendations regarding risk factors, lifestyle, treatment, monitoring and diagnostic advices.

More importantly, the system is capable of making a risk assessment for the patient despite that some medical data are missing, where obviously the less data are input into the system the less will the reliability of the outcome from the system, and vice versa, the more data the patient (or the healthcare provider) inputs the better will the reliability of the diagnosis outcome from the system be.

The system may also be used by health professionals for enabling an earlier diagnosis, which obviously will reduce the costs of the health care system enormously since the results may e.g. pinpoint which tests should be run or whether further clinical findings should be evaluated.

Further, the system provides an important tool in reducing the number of diagnosis errors leading to delays in correct therapeutic interventions and treatment failures for the patient.

The input module may as an example comprise any type of device, e.g. tablet, phone, computer and the like, that receives input data from the patient, e.g. the sex, the age, the weight, symptoms information from every organ etc., where this information is processed by the processor for “locating” the patient within the unique classification rules.

The term object findings may be understood as an objective indication of some medical fact or characteristic that may be detected by a medical expert during a physical examination or by a clinical scientist by means of an in vivo examination of a patient. For example, whereas paresthesia or pain is a symptom (only the person experiencing it can directly observe their own tingling or painful feeling), erythema is a sign (anyone can confirm that the skin is redder than usual). Symptoms and signs are often nonspecific, but often combinations of them are at least suggestive of certain diagnoses, helping to narrow down what may be wrong. In other cases they are specific even to the point of being pathognomonic (i.e. disease defining). Some signs may have no meaning to the patient, and may even go unnoticed, but may be meaningful and significant to the healthcare provider in assisting diagnosis.

Examples of signs include elevated blood pressure and a clubbing of the fingers (which may be a sign of lung disease, or many other things)”.

In one embodiment, the interactive rules associated to the two or more different medical training data sources are governed by mathematical functions whereby the variable factors of the functions are the first and the at least one second weight factors. Thus, in one instance the relations ship between an independent risk factor is directly proportional to a given condition or specific diseases. However, when combined with another risk factor (with its own independent risk association) the combination of the two will not result in an additive risk (i.e. 1+2=3), but will have synergistic effects upon the same risk (e.g. 1+2=16). The biological definition of synergistic effect is when a given risk factor (physical finding, chemical substances or biological structures) interact resulting in an overall effect that is greater than the sum of individual effects of any of them.

In another embodiment, the interactive rules associated to the two or more different medical training data sources are defined by a look-up table indicating how different values of the first and the at least one second weight factors result in different clinical weight factors.

The interactive rules should not be construed to the mathematical functions and/or the look up table, but different tools may be implemented to determine the at least one clinical weight factor, such as neural network based modelling, artificial intelligence methods at the like.

Neural Network Models have been found useful in order to improve the diagnostic accuracy. Neural networks provide a new innovative way of approaching clinical problems. When the output of the network is categorical, it is performing prediction and when the output has discrete values then it is doing classification. Thus, with its implementation Neural Network based Decision Support in medicine has been found to have a significant role in enhancing the consistency of care.

An artificial neural network model was trained on patient specific objective findings to accurately predict many of the risk factors associated with the given disease. Results have shown that in some of these instances, the artificial neural network performs significantly better than a logistic regression model (area under the receiver operator curve).

In one embodiment, the independent weight factors within the two or more different medical training data sources are within a pre-defined weight value range and where the severity of the objective findings within each data source is indicated by different values within the pre-defined weight value range. As an example, the pre-defined weight value may be 0-1 or 0-10, where e.g. 0 indicates no weight and 1 or 10 indicates maximum weight. As an example, one medical training data sources may be weight, where e.g. weight between 50-70 kg is associated with the value 0 (no weight), 70-80 kg is associated with the weight value 1, 80-90 kg is associated with the weight value 3, etc. Accordingly, a number of medical experts are preferably needed to utilize their knowledge in transferring the objective findings into numerical values, i.e. the weight factors. Obviously, this is a very time-demanding process but which in the end results in the above mentioned clinical decision support system.

Another medical training data may be male or female, where male may be associated with the value 3 (or e.g. 0.3) whereas female may be associated with the value 6 (e.g. 0.6) meaning that female has more tendency to suffer from this particular disease than male. This is particularly associated with the risk of developing many of the diseases associated with osteoporosis and systemic autoimmunity. Thus, females are much more likely to develop both of these than males at any given age.

In one embodiment, the independent weight factors within the two or more different medical training data sources are defined by medical experts where the severity of the objective findings within each data source is indicated with values within the pre-defined weight value range.

Thus, a diagnostics tool has been developed that can knowledge-map numerous and complex disease specific data for providing a prediction for disease. The complex nature of the data available for this purpose required the development of new implementations for known data mining methods. Using these new implementations lead to the final outcome of an expert system that is able to mimic the decision-making processes of experts in that given field.

In one embodiment, the system further comprises triggering, upon that the severity of the objective findings within a data source indicated by independent weight factors changes, a signal instructing the computer program to updated the knowledge mapping by means of repeating steps a)-c) so as to update the update the unique classification rules. In that way, the knowledge mapping becomes updated in case e.g. new objective finding are discovered or if e.g. new research shows that a particular objective finding, e.g. smoker/no-smoker, is more severe than researcher though before. The unique classification rules are thus obtained up to date at all times.

As an example, an expert that manages the medical data sets and the clinical support system may manually indicate this change and thus instructing the computer program to update the knowledge mapping. New finding may obviously affect the unique classification rules and thus different diagnosis.

In one embodiment, the unique classification rules are defined in at least one decision tree where the different branching in the decision tree indicate different clinical weight factors, wherein the step of comparing the received medical data to the unique classification rules comprises positioning the patient within the at least one decision tree.

In one embodiment, the associated weight value of the clinical weight factor where the patient is positioned within the at least one decision tree is utilized as input data in extracting the appropriate personalized medical assessment indicator for the patient. This assessment indicator may e.g. comprise the groups of: “no risk”, “very low risk”, “low risk”, “medium risk” and “high risk”. This may be presented to the user visually on e.g. any type of display.

In one embodiment, the appropriate personalized medical assessment indicator is indicated in ascending order values where the higher the order is the more severe is the diagnosis of the disease.

Such an instance can been found for the risk of having Sjögrens syndrome, where a low value of the biomarker SSA is associated with a low risk of having the disease, whereas, a high value of the same biomarker is associated with a high risk of Sjögrens syndrome.

In one embodiment, the system further comprises a display operated by the processor wherein the ascending order values are adapted to visually presenting the severity visually to the patient. Thus, a user friendly way is provided for presenting the patient with the diagnosis results, but this could e.g. be done by displaying colour code to the patent or via artificial meter that illustrates graphically the diagnosis results to the patient.

In one embodiment, the personalized medical assessment indicator triggers at least one of the following recommendations:
diagnostic recommendation,
therapeutic medical recommendation
preventive personalized life-style recommendation,
follow up recommendation.

The clinical decision support system may in one embodiment be used as Osteoporosis Risk calculator for monitoring and diagnosing Osteoporosis, where the system has been extendedly tested and the product received its CE marking (Comformité Eurpéenne) in July 2012. The reliability of the Osteoporosis Risk calculator has been tested in several steps. Initially the outcome measurements given by Osteoporosis Risk calculator were tested by randomly running selected cases against selected expert panel, which consists of various specialists; all interested in osteoporosis: endocrinologists, geriatricians, rheumatologists and general practitioners. The evaluation process of the Osteoporosis Risk calculator has mainly consisted of three steps. Firstly, the 10-years fracture probability was calculated by Osteoporosis Risk calculator for several hundred cases of different origins (Denmark, Finland, French, Germany, Italy, Netherlands Norway, Swedes and US (Afro-Americans, Asian, Caucasian, Hispanic) and compared to results given by FRAX, which is the golden standard when evaluating the fracture risk. Results demonstrated excellent correlation between the risk values given by Osteoporosis Risk calculator and FRAX, were R2-values are 0.959-0.988 with a mean paired difference of only 0.7-1.8% (SD 1.99%) with great significant accuracy (p<0.0001).

Secondly, the time to the next bone mineral density given by Osteoporosis Risk calculator has been evaluated according to international guidelines and recommendations. The main findings have surprisingly demonstrated that more than ⅓ of all DXA measurements at a hospital do not add to clinical fracture risk evaluation and may therefore be unnecessary.

Thirdly, the Osteoporosis Risk calculator has undergone extended evaluation of the clinical recommendations where they have been compared to the recommendation given by osteoporosis specialist. The main findings demonstrate that when no additional treatment is recommended by the entirety, the specialists agree in 90% of the cases, and both recommend specific treatment in 31% of all cases. The recommendation given by the entirety and a specialist results in a fair agreement evaluated by the kappa value of 0.34 (p 0<0.001).

In a second aspect of the invention, a computerized diagnostic method is provided for diagnosis and monitoring of a disease of at least one patient, the method comprising:
storing medical data sets from two or more different medical training data sources at a storage media in a computer system, where each of the two or more different medical training data sources have uniquely defined objective findings influencing the disease, the severity of the objective findings within each data source being indicated by independent weight factors,
performing, via a computer program operating on the computing system, a knowledge mapping between the data in the two or more different medical training data sources, where the knowledge mapping includes:
   a) receiving a first and at least one second weight factors from a first and at least one second medical training data sources selected from the two or more different medical training data sources,
   b) determining, based on the received weight factors, at least one clinical weight factor by means of utilizing interactive rules associated to the two or more different medical training data sources, the at least one clinical weight factor indicating the severity of the combination of the first and the at least one second symptom weight factors to the disease,
   c) repeating steps a) and b) for the remaining weight factors within the two or more different medical training data sources so as to determine the remaining clinical weight factors resulting in a unique classification rules,
receiving, via an input module, medical data about a patient, and
processing, via a processor, the received medical data from the input module, where the processing includes:
   comparing the receive medical data to the unique classification rules, and based thereon
   extracting an appropriate personalized medical assessment indicator for the patient.

In one embodiment, the medical data about the patient comprise:
the gender of the patient,
the age of the patient,
the weight of the patient,
the symptoms from one or more organ systems.

In a third aspect of the invention, computer readable medium is provided for diagnosing and monitoring of a disease of at least one patient, the computer readable code comprising instructions which when executed by a processor perform the method of:
performing, via a computer program operating on a computing system, a knowledge mapping between data in two or more different medical training data sources stored at a storage media in the computer system, where each of the two or more different medical training data sources have uniquely defined objective findings influencing the disease, the severity of the objective findings within each data source being indicated by independent weight factors, where the data where the knowledge mapping includes:
   a) receiving a first and at least one second weight factors from a first and at least one second medical training data sources selected from the two or more different medical training data sources,
   b) determining, based on the received weight factors, at least one clinical weight factor by means of utilizing interactive rules associated to the two or more different medical training data sources, the at least one clinical weight factor indicating the severity of the combination of the first and the at least one second symptom weight factors to the disease,
   c) repeating steps a) and b) for the remaining weight factors within the two or more different medical training data sources so as to determine the remaining clinical weight factors resulting in a unique classification rules,
receiving, via an input module, medical data about a patient, and
processing, via a processor, the received medical data from the input module, where the processing includes:
   comparing the receive medical data to the unique classification rules, and based thereon
   extracting an appropriate personalized medical assessment indicator for the patient.

In general the various aspects of the invention may be combined and coupled in any way possible within the scope of the invention. These and other aspects, features and/or advantages of the invention will be apparent from and elucidated with reference to the embodiments described hereinafter.

### BRIEF DESCRIPTION OF THE DRAWINGS

Embodiments of the invention will be described, by way of example only, with reference to the drawings, in which

FIG. 1 shows a clinical decision support system according to the present invention for diagnosis and monitoring of a disease,

FIGS. 2-6 depict an example of an implementation of the present invention, where the decision support system is implemented for diagnosing Osteoporosis,

FIGS. 7-13 show another example of implementation of the present invention, where the decision support system is utilized as an Autoimmune Advisor, and

FIG. 14 shows a flow diagram of a method according to the present invention for diagnosis and monitoring of a disease.

### DESCRIPTION OF EMBODIMENTS

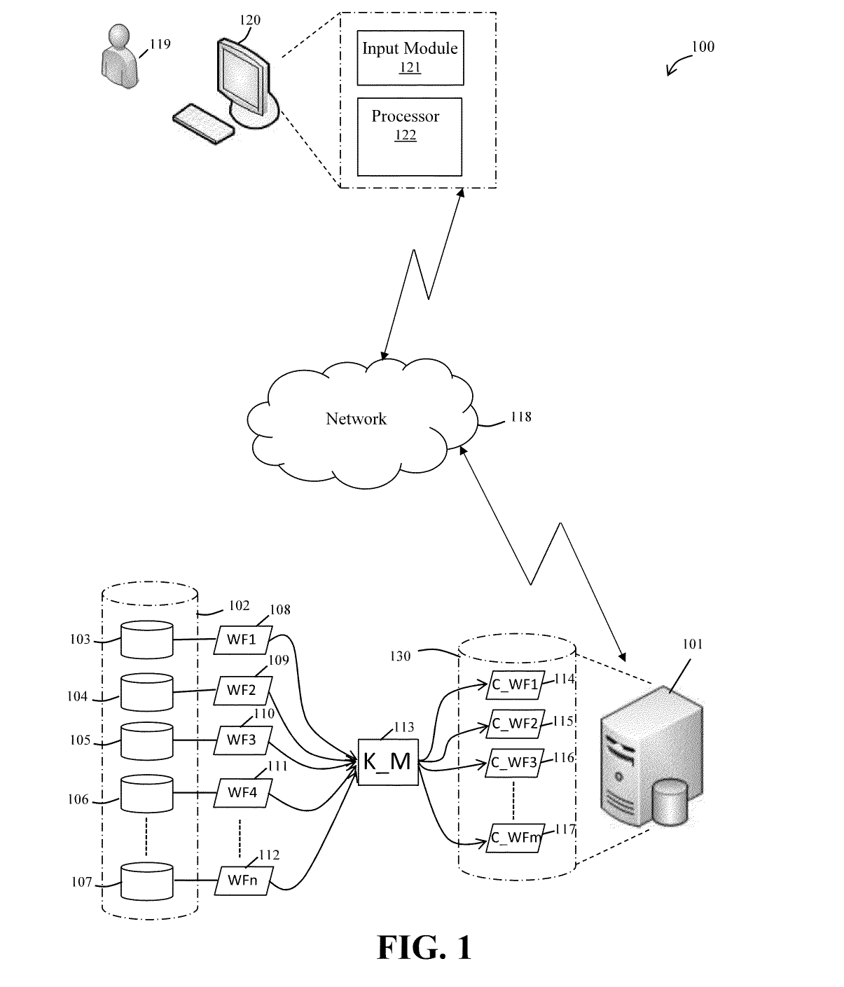

FIG. 1 shows a clinical decision support system 100 according to the present invention for diagnosis and monitoring of a disease, e.g. Systemic Autoimmune diseases, of at least one patient. The system comprises a computing system 101, a storage media 102, in communication with the computer system 101, for storing medical data sets from two or more different medical training data sources 103-107. Each of the two or more different medical training data sources 103-107 have uniquely defined objective findings influencing the disease, where the severity of the objective findings within each data source is indicated by independent weight factors 108-112.

The object findings may be understood as an objective indication of some medical fact or characteristic that may be detected by a medical expert during a physical examination or by a clinical scientist by means of an in vivo examination of a patient. For example, whereas paresthesia or pain is a symptom (only the person experiencing it can directly observe their own tingling or painful feeling), erythema is a sign (anyone can confirm that the skin is redder than usual). Symptoms and signs are often nonspecific, but often combinations of them are at least suggestive of certain diagnoses, helping to narrow down what may be wrong. In other cases they are specific even to the point of being pathognomonic (i.e. disease defining). Some signs may have no meaning to the patient, and may even go unnoticed, but may be meaningful and significant to the healthcare provider in assisting diagnosis.

Examples of signs include elevated blood pressure and a clubbing of the fingers (which may be a sign of lung disease, or many other things)”.

The clinical decision support system 100 further comprises a computer program operating on the computing system 101, where the computer program is configured to perform a knowledge mapping between the data in the two or more different medical training data sources 103-107. The knowledge mapping comprises:

a) Receiving, by a knowledge mapping engine 113 such as any type of computing device comprising a processing unit, a first and at least one second weight factors 108-112 from a first and at least one second medical training data sources selected from the two or more different medical training data sources 108-112.
b) Determining, based on the received weight factors, at least one clinical weight factor 114-117 by means of utilizing interactive rules associated to the two or more different medical training data sources, where the at least one clinical weight factor indicate the severity of the combination of the first and the at least one second symptom weight factors to the disease.
c) Repeating steps a) and b) for the remaining weight factors within the two or more different medical training data sources so as to determine the remaining clinical weight factors resulting in a unique classification rules. These clinical weight factors are stored in database 130, which may be the same as database 102.
Accordingly, preferably, all possible combinations of weight factor is received, e.g. WF1+WF2, WF1+WF2+WF3, WF2+WF3, WF1+WF4, WF1+WF2+WF4, WF1+WF2+WF3+WF4 etc.

The first and at the least one second weight factors may as an example be the weight of the patient (e.g. the first weight factor), whether the patient smokes or not (e.g. the second weight factor), whether the patient is male or female (e.g. the third weight factor), symptoms from different organs such as number of joints affected by pain or swelling (e.g. the fourth weight factor). The interactive rules automatically evaluate how the clinical weight factors 114-117 and thus the severity of the disease of the combination of the two or more weight factors changes, but different combinations may result in completely different results. As an example, the severity of the combination of these weight factors may be completely different if the patient is obese (e.g. above 100 kg) compared to if the patient is thin (e.g. 55 kg), or the severity may be completely different if the patient is male and not female, or if the patient has two joints affected by pain or swelling instead of one.

The interactive rules associated to the two or more different medical training data sources may be governed by mathematical functions, whereby the variable factors of the functions are the first and the at least one second weight factors, and/or the interactive rules associated to the two or more different medical training data sources may be defined by a look-up table indicating how different values of the first and the at least one second weight factors result in different clinical weight factors. The interactive rules should not be construed to the mathematical functions and/or the look up table, but different tools may be implemented to determine the at least one clinical weight factor, such as neural network based modelling, artificial intelligence methods at the like, or simply the knowledge from the medical expert(s).

Accordingly, combination off two or more weight factors will not result in an additive weight or risk, i.e. 1+2=3, but will have synergistic effects upon the same risk, e.g. 1+2=16. The biological definition of synergistic effect is when a given risk factor (physical finding, chemical substances or biological structures) interacts resulting in an overall effect that is greater than the sum of individual effects of any of them. This may e.g. be based on researches where e.g. new research has shown that the weight of the patient has a given weight, e.g. 0.3 (in the scale 0-1), but in combination with another weight factor, e.g. whether the user is a smoker or non-smoker, may have multiple weight. As an example, if the weight of the patient is obese (e.g. above 100 kg) and is additionally heavy smoker (e.g. more than 20 cigarettes a day), the weight or risk may be multiple compared to if the patient is obese (e.g. above 100 kg) but non-smoker. If this is a newly published research, this information would typically be entered manually into the system by e.g. a medical expert, i.e. that this combination (obese+heavy smoker) has the above mentioned weight compared to if the patient is non-smoker.

Various tools may be utilized to perform the knowledge mapping such as Neural Network Models have been found useful in order to improve the diagnostic accuracy. Neural networks provide a new innovative way of approaching clinical problems. Typically, when the output of the network is categorical, it is performing prediction and when the output has discrete values then it is doing classification. Thus, with its implementation Neural Network based Decision Support in medicine has been found to have a significant role in enhancing the consistency of care.

The weight factors within the two or more different medical training data sources are preferably set within a pre-defined weight value range, e.g. 0-1 or 1-10, and where the severity of the objective findings within each data source is indicated by different values within the pre-defined weight value range. The weight factors are defined by medical experts and where the severity of the objective findings within each data source is indicated with values within the pre-defined weight value range. It is thus the medical experts experience that determines the value bases in his knowledge and experience. Thus, e.g. a heavy smoker (e.g. more than 20 cigarettes a day) may be decisive in that the value of e.g. 0.8 is set (scale 0-1) by a medical expert in the medical training data sources related to whether the patient is a smoker or non-smoker.

The clinical decision support system 100 further comprises an input module 121 and a processor 122, which may be a part of a computing device 120, adapted to receive medical data about a patient 119. The input module may e.g. be a keyboard and/or a computer mouse, or be a tablet computer or a mobile phone where via touch screen selection from the patient, the medical data are received. This will be discussed in more details later. The processor 122 is among other things configured to compare the received medical data about the patient 119 to the unique classification rules stored in database 130 via wired or wireless network 118b such as the Internet, and based thereon extract appropriate personalized medical assessment indicator for the patient.

In case there are new discoveries show that the severity of the objective finding changes, e.g. the symptoms from different organs such as number of joints affected by pain or swelling may have much more severe objective findings than medical experts expected. In such cases, it is important to update the unique classification rules and adapt it to the new discovery. This may be done by e.g. triggering, upon that the severity of the objective findings within a data source indicated by independent weight factors changes, a signal instructing the computer program to updated the knowledge mapping by means of repeating the above mentioned steps a)-c) so as to update the update the unique classification rules. The triggering may be done by a medical expert, or an updated centralized database by perform this triggering automatically.

In one embodiment, the unique classification rules is defined in at least one decision tree where the different branching in the decision tree indicate different clinical weight factors, wherein the step of comparing the receive medical data to the unique classification rules comprises positioning the patient within the at least one decision tree. The decision tree may comprise hundreds, thousands or tens of thousands different branching and where, based on the patient's medical data, it is always possible to locate the patient within the decision tree and extract an appropriate personalized medical assessment indicator for the patient, also when some patients data are missing. The medical assessment indicator may as an example indicated in ascending order values the diagnosis of the disease where the higher the order is the more severe is the diagnosis of the disease.

In a preferred embodiment, the clinical decision support system 100 further comprises a display operated by the processor 122 for visually presenting the ascending order values to the patient. This will be discussed in more details later. The personalized medical assessment indicator may also triggers at least one of the following recommendations: diagnostic recommendation, and/or therapeutick medical recommendation, and/or therapeutic and preventive life-style recommendation, and/or follow up recommendation.

### EXAMPLES

The clinical decision support system according to the present invention was created to operate at the level of a world-class medical expert. To accomplish this team of international specialists have spent over 10 years in compiling, analyzing, and interpreting all available information and data in particular medical fields from various internationally recognized sources. This eventually led to a database of information that provides the artificial intelligence of the system with the same level of information that a world-class specialist would have available to him. The system has been configured to follow the same rules of differentiation that the world-class specialist has in his mind. This flow of information is partially linear and partially abstract, depending on what variables are interacting with each other at any given time. At the core of system's proprietary technology is the unique ability of system's artificial intelligence to create numerous sets of interactive rules. As information is fed into the system, these rules are activated and the massive amount of information is processed and interpreted based on the artificial intelligence “thinking.” It is through this complex process that any new information that is fed into the system is immediately processes, providing the user of the system with international top-level recommendations which include preventative measures, diagnostic work-up, diagnosis, and finally, personalized treatment recommendations.

Due to the fact that the system may be based on artificial intelligence, it never forgets the information that has been fed into it (unlike a human medical specialist). It also does not get tired and it does not forget to ask for crucial medical information from its user/patient, which is critical to provide the best possible care. Additionally, it is preferably constantly updated with new research and medical knowledge. Because of this, the system functions like a world-class specialist on a perfect day. Finally, the system is preferably constantly being updated with the newest published medical knowledge and international guidelines and standards.

In the two examples that will be discussed in more details below, the system includes, but is not limited to, 6 massive databases, i.e. different medical training data sources. These include Case Study Database, Best Practices Database, Risk Assessment Database, Disease-Specific Database, Disease-Management Database, and Quality Assurance Database.

The Case Study Database contains collection of international case studies. These case studies are sourced from multinational leading research institutes. All of the inputted data is scientifically recognized by the top leadership in each field and includes the important data sets approved by the World Health Organization (WHO).

The Best Practices Database is a collection of all relevant international guidelines of best medical practices for each disease category (e.g. osteoporosis, autoimmune disease).

The Risk Assessment Database identifies the risk factors associated with each disease. It collects all known risk factors associated with each disease. Each risk factor is very complex and has multiple variances (levels) and variables. Taking into account all of these variances and how they interact and affect each other in the system according to the present invention, the complexity of the risk factors is exponentially more complicated.

The Disease-Specific Database follows the same logic as the risk assessment database. It contains all of the known knowledge, which has been published and is available worldwide on each disease. The Disease Specific database contains all relevant known clinical information on the disease including symptoms and the disease's potential complications.

The Disease-Management Database follows the same logic as the risk assessment and disease-specific databases. The Disease Management database contains all relevant known clinical information on the ways the disease should be prevented, diagnosed (including testing, etc), and treated. It also includes recommended follow-up.

The Quality Assurance Database reviews and qualifies the databases in system according to the present invention. Thus, analyzing the efficacy, quality and accuracy of every single database.

The system is the pre-requisite to the creation of Artificial Intelligence Rules that work in a similar manner to how a specialist would think through a patient's diagnostic process. As will be discussed in more details below with these artificial intelligence rules, a patient's information is fed through the system. Depending on the patient, these rules react to the information being inputted. The system is flexible to the information on each individual patient. This core artificial intelligence system, through which all information is processed, is the “brain” of the system. It is through this complexity that system's artificial intelligence “mind” can think like a world-class specialist working at his highest capacity.

### Begin Example 1

### Osteoporosis Risk Calculator

There are over 200 sets of interactive rules behind Osteoporosis Risk calculator.

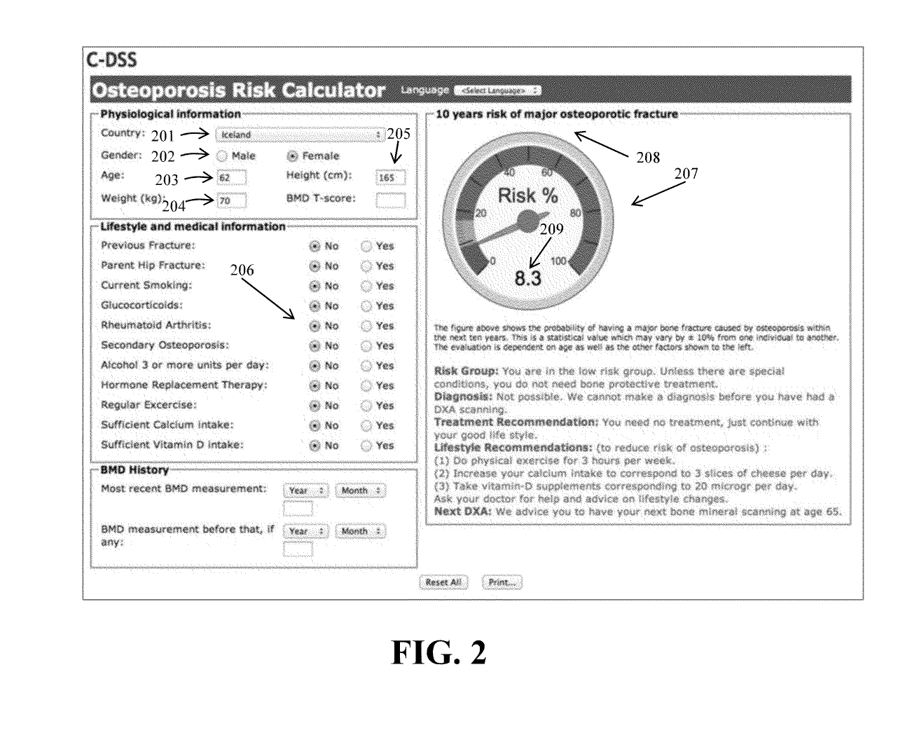

FIGS. 2-6 depicts an example of implementation of the present invention, where the decision support system is implemented for diagnosing Osteoporosis and is already used by many medical experts, medical institutes and patients.

As FIG. 2 shows, a 62 year old 203 female 202 patient from Iceland 201 that is 165 cm tall 205 and weighs 70 kg 204. This patient has 10 year risk 208 of 8.3% 209 of a major osteoporotic fracture as indicated in the risk meter 207 and the pointer. The green colour codes indicate visually that there is no risk and where the risk increases successively with the percentages (and the colour). As shown here, there are a number of other questions 206 that the patient has not yet been replied to.

The platform shown here is only one example of a user friendly platform that may be implemented to receive the patients input, e.g. via “yes” and “no” answers 206, via pre-defined selection criteria such as a country list 201 and the like.

This platform may be provided to the patient or a medical expert via any type of computing means, such as any type of tablets, mobile phones, computer devices etc. where the computer device may interact with e.g. a central database via the Internet, as discussed in relation to FIG. 1.

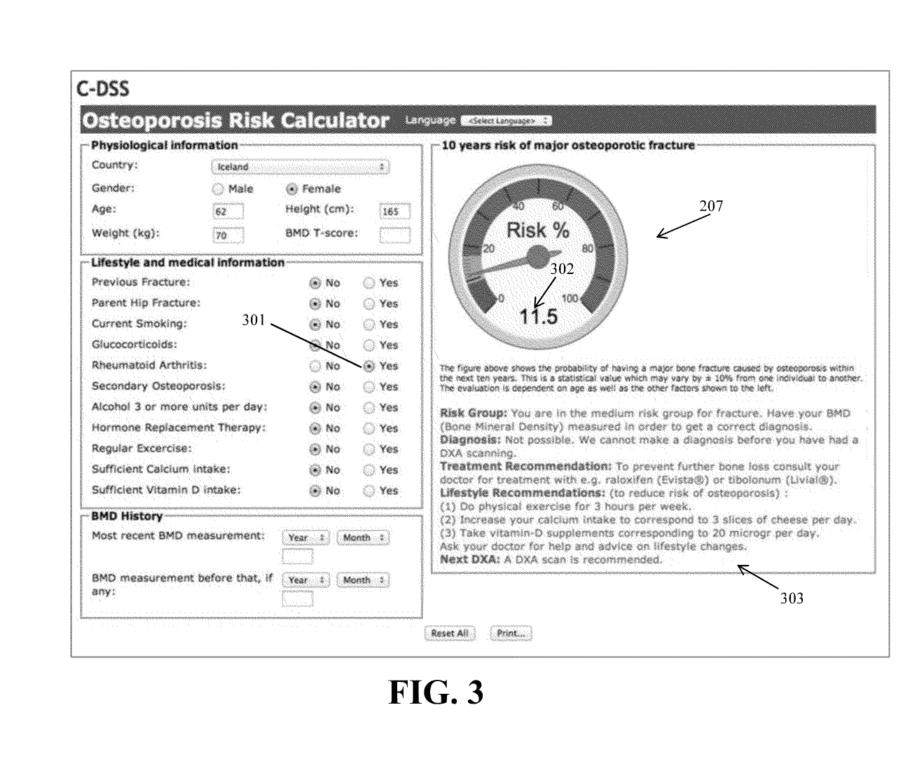

In FIG. 3 a risk factor has been added to the case shown in FIG. 2. As shown, with a history of Rheumatoid arthritis 301, the outcome measure has changed significantly, i.e. from 8.3% to 11.5% 302. Both has the risk now changed from a green colour coded zone into a yellow as indicated in the risk meter 207. The treatment and follow up recommendations 303 changed as well compared to FIG. 2. At this stage, both a specific treatment and further testing plan is recommended.

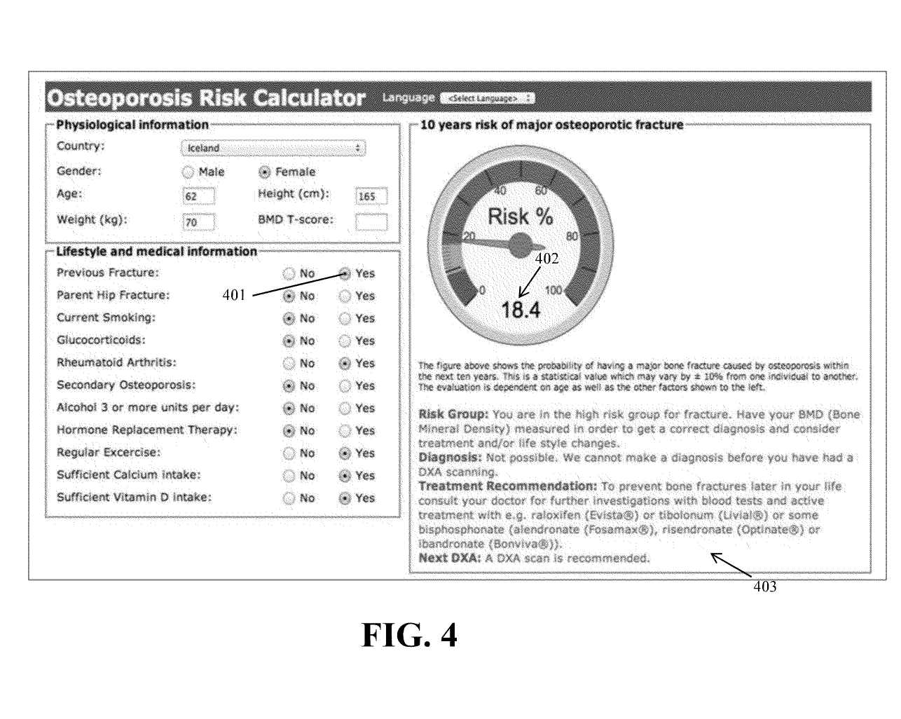

FIG. 4 shows where the risk factor history of the woman presented in FIG. 3 has been changed. Thus, if she would have sustained a previous fracture 401 immediately places her in a red high-risk category, 18.4% 402, with recommendations 403 of a specific treatment and further testing specifications.

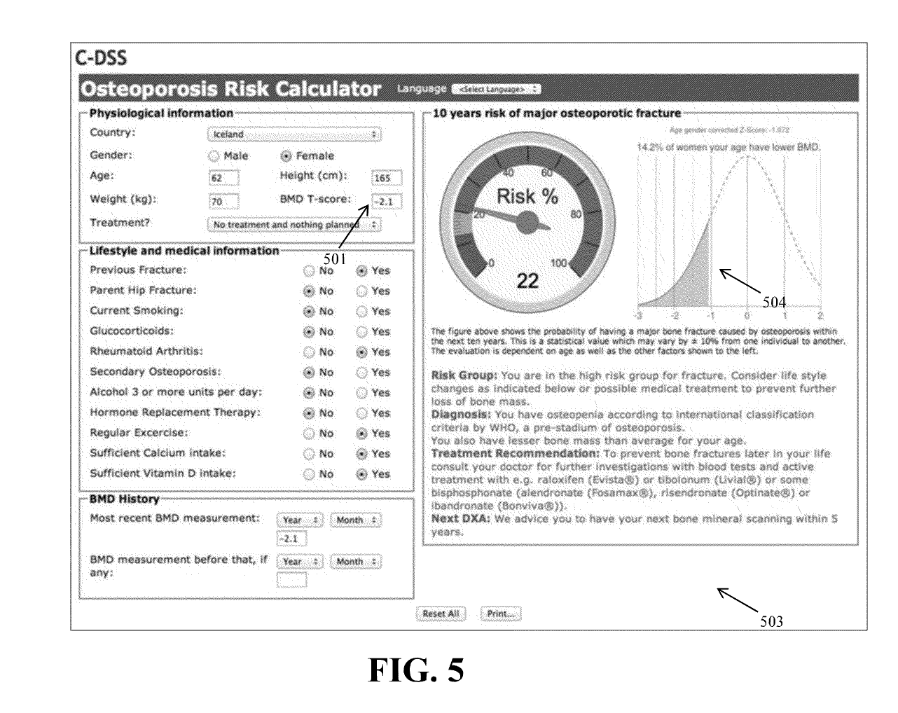

FIG. 5 shows where the female presented in FIG. 3 has had a DEX scan done with the outcome of a BMD T-score being −2.1 501. Now the system has been provided with enough combination of data to be able to provide a disease specific personalized treatment and follow up plan, unique to that individual.

As shown here, the system also, in a unique graphical manner, compares the women with other women's at her own age by means of illustrating a statistical comparison 504 of the women/patient with other women's of her age having similar profile, where the diagram states: “14.2% of women your age have lower BMD”. The treatment and follow up recommendations 503 changed as well stating e.g. under “Next DXA: We advice you to have your next bone mineral scanning within 5 years”.

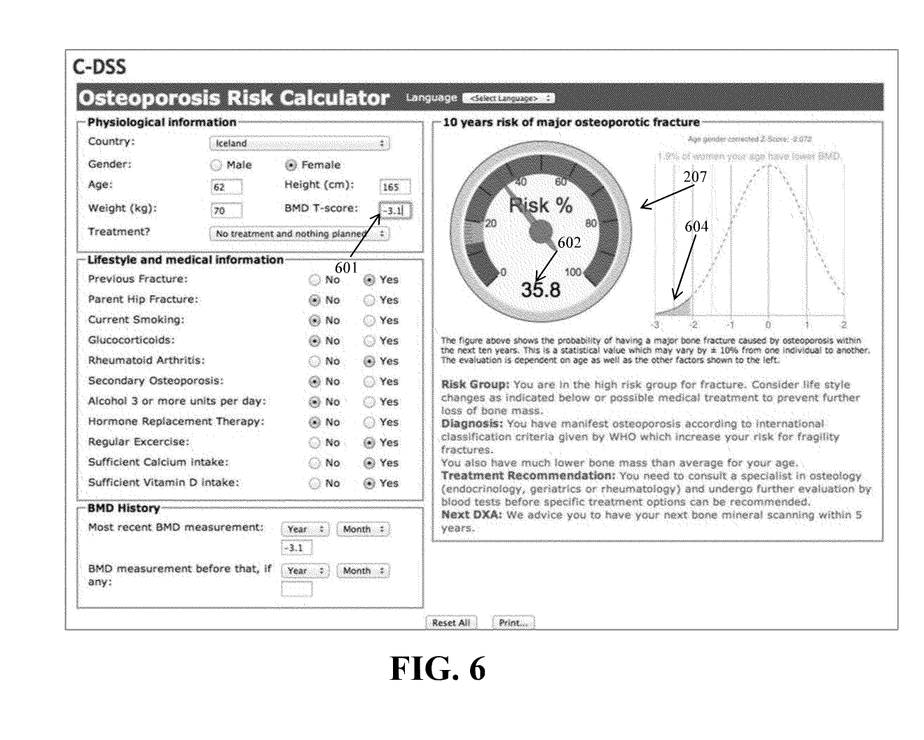

In FIG. 6, of this case series, the DXA outcome has been changed for the woman presented in FIG. 5 into −3.1. As shown here, this “small” change places her in complexity outside the scope of all known protocols, indicating for a serious underlying cause for her osteoporosis. This is both indicated via the risk meter 207, the percentage 602 and the statistical chart 604, where the women is placed at the tail of the Gaussian curve shown here and where it is stated that 1.9% of women her age have lower BMD.

The treatment and follow up recommendations sections shown here by be text strings that are associated to the clinical weight factors whereby extracting the personalized medical assessment indicator for the patient these text strings are automatically presented to the user. The same applies to the diagrams discussed above and the text strings associated to the diagrams.

The Osteoporosis Risk calculator has been extendedly tested and the product received its CE marking (Comformité Eurpéenne) in July 2012. The reliability of the Osteoporosis Risk calculator has been tested in several steps. Initially the outcome measurements given by Osteoporosis Risk calculator were tested by randomly running selected cases against selected expert panel, which consists of various specialists; all interested in osteoporosis: endocrinologists, geriatricians, rheumatologists and general practitioners. This process and design of the Osteoporosis Risk calculator is thoroughly descripted in a reacent publication: A Clinical Decision Support System for the Diagnosis, Fracture Risks and Treatment of Osteoporosis, published in Computational and Mathematical Methods in Medicine (www.hindawi.com/journals/cmmm/aa/189769/), hereby incorporated by reference in its entirety.

The evaluation process of the Osteoporosis Risk calculator has mainly consisted of three steps. Firstly, the 10-years fracture probability was calculated by Osteoporosis Risk calculator for several hundred cases of different origins (Denmark, Finland, French, Germany, Italy, Netherlands Norway, Swedes and US (Afro-Americans, Asian, Caucasian, Hispanic) and compared to results given by FRAX, which is the golden standard when evaluating the fracture risk. FRAX has been supported by WHO (www.shefac.us/FRAX/). Results demonstrated excellent correlation between the risk values given by Osteoporosis Risk calculator and FRAX, were R2-values are 0.959-0.988 with a mean paired difference of only 0.7-1.8% (SD 1.99%) with great significant accuracy (p<0.0001).

Secondly, the time to the next bone mineral density given by Osteoporosis Risk calculator has been evaluated according to international guidelines and recommendations. The main findings have surprisingly demonstrated that more than ⅓ of all DXA measurements at a hospital do not add to clinical fracture risk evaluation and may therefore be unnecessary, (www.laeknabladid.is/fylgirit/fylgirit/2015/fylgirit-82/agriperinda/(E88)), hereby incorporated by reference in its entirety. Thirdly, the Osteoporosis Risk calculator has undergone extended evaluation of the clinical recommendations were they have been compared to the recommendation given by osteoporosis specialist. The main findings demonstrate that when no additional treatment is recommended by the entirety, the specialists agree in 90% of the cases, and both recommend specific treatment in 31% of all cases. The recommendation given by the entirety and a specialist results in a fair agreement evaluated by the kappa value of 0.34 (p 0<0.001). These results will be presented at the World Congress of Osteoporosis held under the hospice of the International Foundation of Osteoporosis in Milan, Italy, Mars 2015: Treatment recommendations given by clinical decision support system in osteoporsosis in comparison to osteology specialist (http://www.wco-iof-esceo.org). Manuscript is under preparation.

### End Example 1

### Begin Example 2

### Autoimmune Advisor

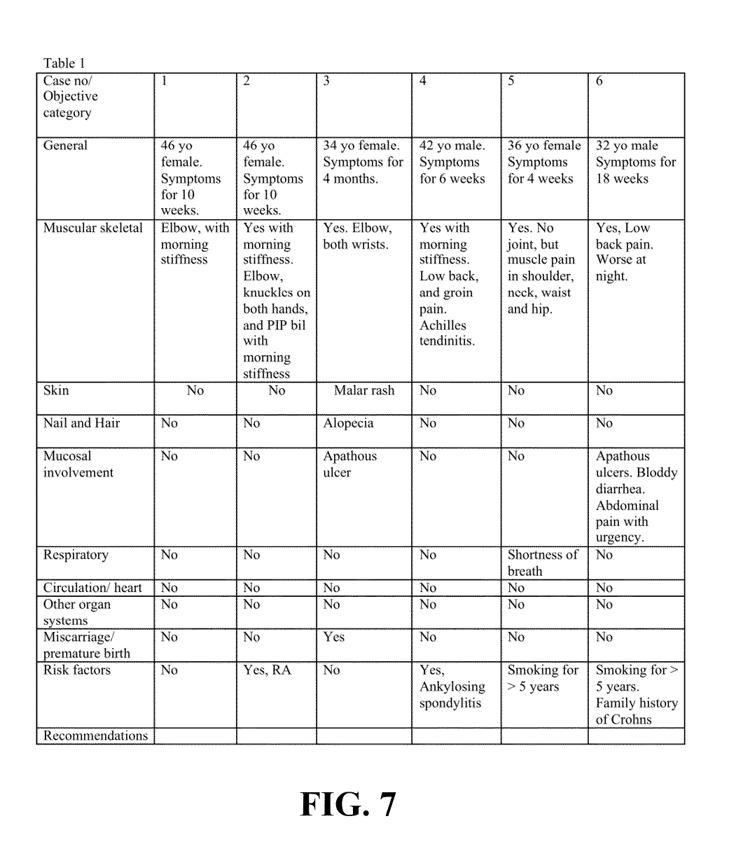

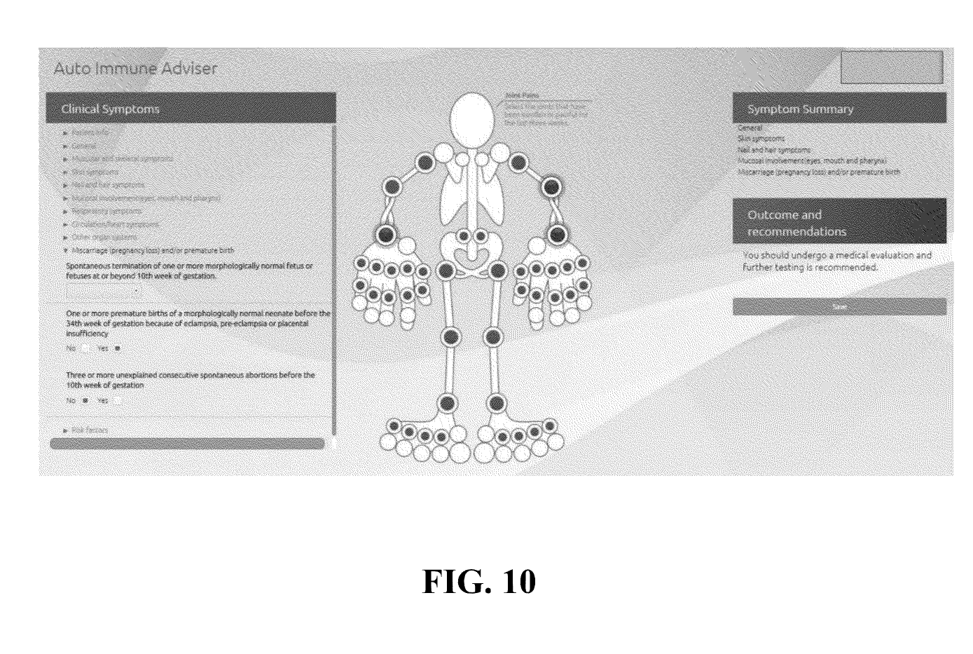

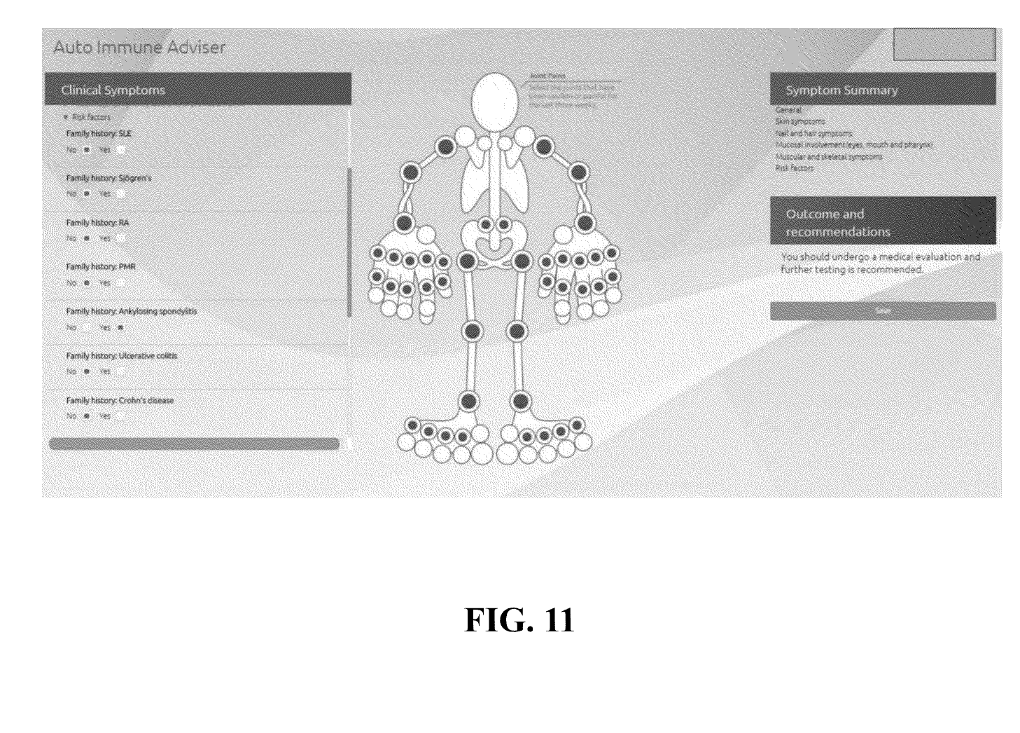

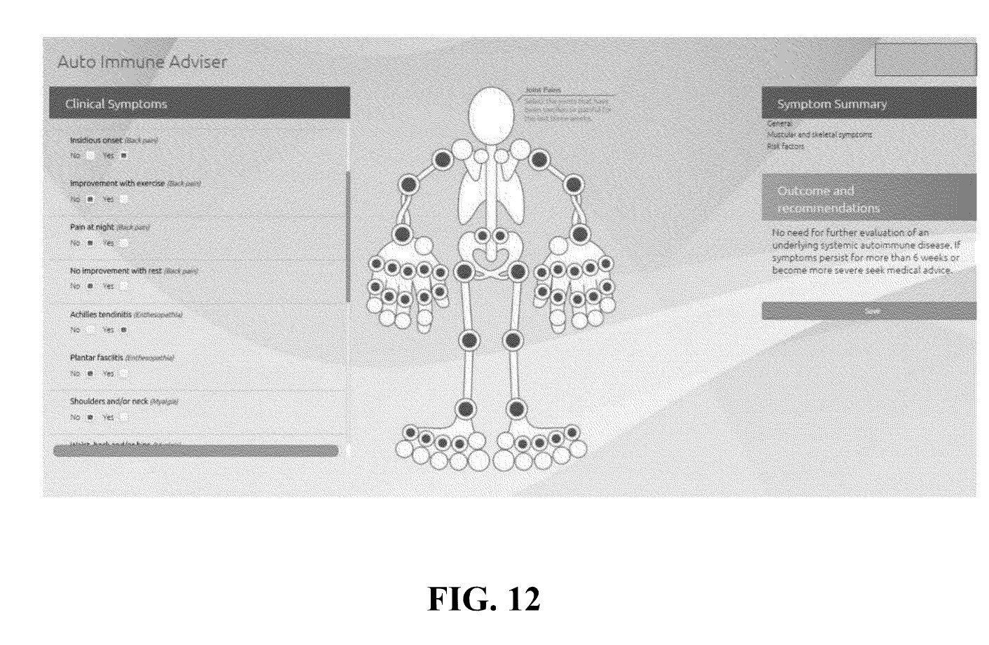

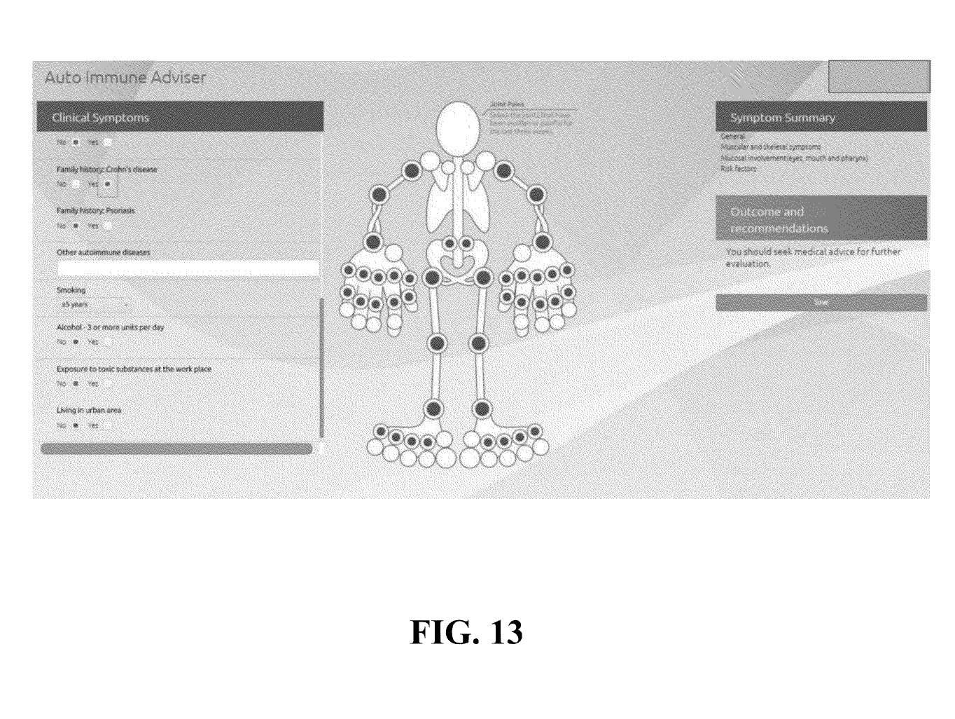

FIGS. 7-13 show another example of implementation of the present invention, where the decision support system is utilized as an Autoimmune Advisor and is already used by many medical experts, medical institutes and patients.

It should be noted that the platform or graphical presentation shown is only one way of providing user friendly platform/interface of implementing the present invention so as to facilitate or optimize the usage or a patient or a medical expert.

The six columns in FIG. 7 (Table 1) illustrating six different cases, and the 10 lines are objective categories, namely the object category “General”, “Muscular skeletal”, “Skin”, “Nail and Hair”, “Mucosal involvement”, “Respiratory”, “Circulation/heart”, “Other organ systems”, “Miscarriage/premature birth”, and “Risk factors”, for the six different cases. These six different cases may be considered as cases for two or more (up to six) different patient.

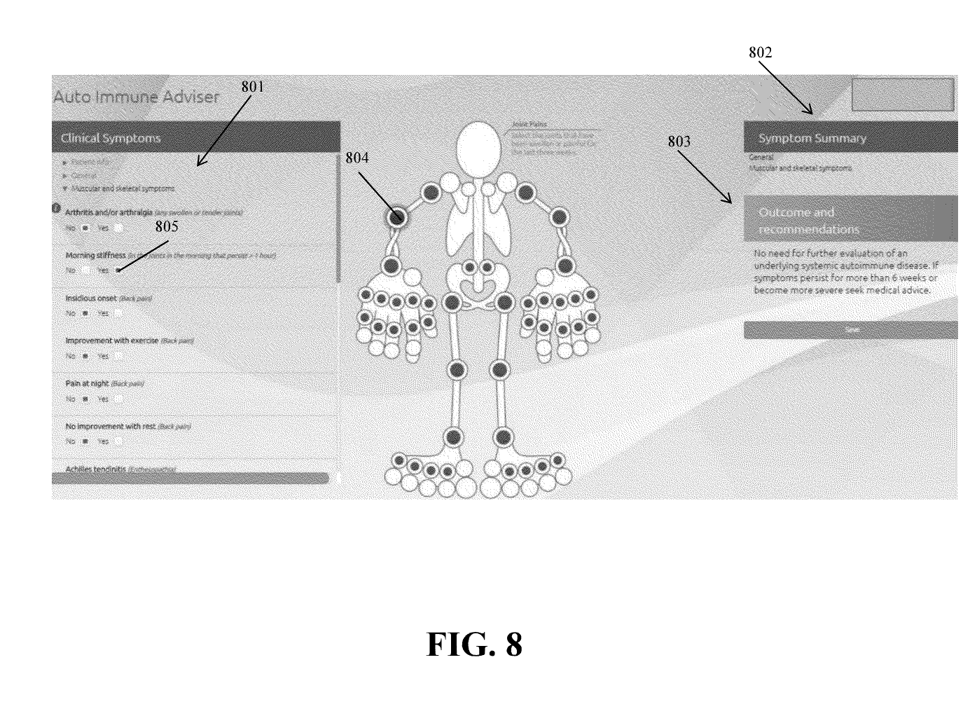

The user platform depicted here may be utilized in touch-screen based devices, e.g. tablets, mobile devices/phones, touch screen implemented screens and the like, where the patient or a medical expert, can simply via touch command select the various criteria, e.g. by clicking directly onto the “skeleton” shown here and/or the by clicking or selecting at Clinical Symptoms column shown on the left side 801 of FIGS. 8-12 where the different questions may via touch commands are to be replied by the patient or the medical expert.

The age of the patient, the sex may, the address, the height, weight etc. may be entered at the very beginning (not shown here) when the patient was logging into the system, or the system may already have these basic information stored and associated to the patient's ID.

The user interface shown in relation to example 1 may just as well be implemented in example 2, and vice versa, the example depicted in example 2 may just as well be used in relation to example 1.

The patient in column 1 is 46 years old, has had symptoms for 10 weeks and has under the objective category “Muscular skeleton” an Elbow, with morning stiffness. The patient has under the remaining objective categories not shown any symptoms. This single symptom may be selected by the patient/medical expert via touch command, as discussed previously, where information about the “Skin”, “Nail and Hair” etc. are entered by the patient himself of the medical expert.

By clicking on the “Muscular skeleton” and by selecting “yes” 805 under Morning stiffness the patient/medical exert can in a user friendly way input symptoms data. In FIG. 8, the patient has symptoms in the right elbow 804. Thus, by selecting the right elbow medical information relating to the patient are automatically triggered and used as input data.

On the right side, there are various information presented depending on the patient's input, or as shown here, “Symptoms Summary” 802 and “Outcome and recommendations” 803. As discussed in relation to the previous example, this data may be text strings that are associated to the clinical weight factors.

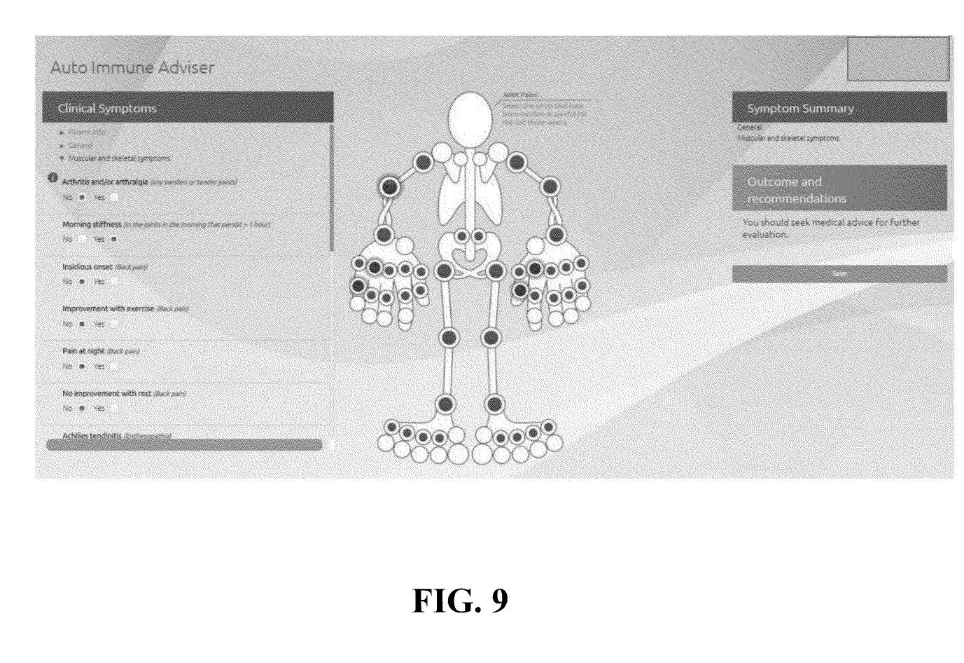

FIG. 9-12 illustrate various scenarios selections from the patient resulting in different medical data about the patient which obviously result in different text strings on the right side under “Symptoms Summary” and “Outcome and recommendations”.

### End Example 2

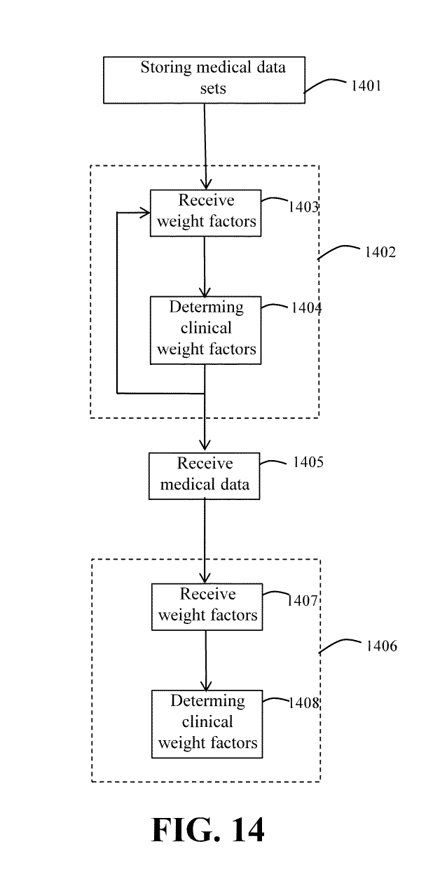

FIG. 14 shows a flowchart of a computerized diagnostic method according to the present invention for diagnosis and monitoring of a disease of at least one patient.

In a first step 1401, medical data sets from two or more different medical training data sources are stored at a storage media in a computer system, where each of the two or more different medical training data sources have uniquely defined objective findings influencing the disease, the severity of the objective findings within each data source being indicated by independent weight factors.

In a second step 1402, a knowledge mapping is performed via a computer program operating on the computing system, a knowledge mapping between the data in the two or more different medical training data sources. The knowledge mapping constitutes of the steps of: a) a step 1403 of receiving a first and at least one second weight factors from a first and at least one second medical training data sources selected from the two or more different medical training data sources, b) a step 1404 of determining, based on the received weight factors, at least one clinical weight factor by means of utilizing interactive rules associated to the two or more different medical training data sources, the at least one clinical weight factor indicating the severity of the combination of the first and the at least one second symptom weight factors to the disease. Steps a) and b) are repeated for the remaining weight factors within the two or more different medical training data sources so as to determine the remaining clinical weight factors resulting in a unique classification rules.

In a third step 1405, medical data about a patient is received via an input module, e.g. via all types of interfaces, e.g. as discussed in relation to FIGS. 1-13.

In a fourth step 1406 the received medical data is processed, where the processing constitutes the step of a) comparing 1407 the received medical data to the unique classification rules, and based thereon b) extracting 1408 an appropriate personalized medical assessment indicator for the patient.

In one embodiment, the knowledge mapping is performed by making used of a decision trees which are available in e.g. R programming language. Among these are two CART algorithms, the tree algorithm and the rpart algorithm. The rpart is a recursive partitioning and regression algorithm, while tree is a more basic classification tree algorithm. Both algorithms are based on a tree-growing method that, in this particular embodiment, consists of three phases:

1. Start with a single node containing all points.

2. Stop if all the points in the node can be assumed to belong to the same class.

3. Otherwise, search over all binary splits of all variables for the one that will reduce the input set as much as possible. If one of the resulting nodes contains less than some predefined number of points, stop. Otherwise, take the split and create two new nodes.

4. Go back to step 1 for each new node.

After having used the built-in CART algorithms as a tool to establishing an ideal structure for the tree, the actual implementation of the tree-based model may begin.

The tree is not a strictly learned tree, in the sense that the separator variables of the branching sites were previously defined. These separators were obtained from both the learned approach of the built-in CART algorithms, but were in some cases those variables that had resulted in highest statistical importance for a specific autoimmune disease. The tree structure is implemented as a series of if-else statements, with each branching taking place at such a statement. The CART algorithms employed linear regression in the leaves of their trees, resulting in a final output value. In those cases where the branching of the trees had lead to a determined section of variables, which all were known to indicate either a high affinity of disease or very low affinity, the numerical values according to the diagnosis induced by those variables (e.g. 4 for a “high” probability of disease or 3 for a “medium” probability) were hard-coded into the model. Thus for extreme, high-probability cases, i.e. where all variables strongly indicated a specific diagnosis, the results are returned as hard-coded values. In those leaves where the division of the input region had not lead to as distinct a result, the final prediction is obtained by a manner of model hybridization, i.e. by adding other classification methods to the classification tree.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage.

1. A clinical decision support system for diagnosis and monitoring of a disease of at least one patient, the system comprising:
a computing system;
a storage media, in communication with the computer system, configured to store medical data sets from two or more different medical training data sources, where each of the two or more different medical training data sources have uniquely defined objective findings influencing the disease, the severity of the objective findings within each data source being indicated by independent weight factors;
a computer program operating on the computing system, the computer program being configured to perform a knowledge mapping between the data in the two or more different medical training data sources, where the knowledge mapping includes:
a) receiving a first and at least one second weight factors from a first and at least one second medical training data sources selected from the two or more different medical training data sources;
b) determining, based on the received weight factors, at least one clinical weight factor by means of utilizing interactive rules associated to the two or more different medical training data sources, the at least one clinical weight factor indicating the severity of the combination of the first and the at least one second symptom weight factors to the disease;
c) repeating steps a) and b) for the remaining weight factors within the two or more different medical training data sources so as to determine the remaining clinical weight factors defining a unique classification rules;
an input module adapted to receive medical data about a patient; and
a processor for processing the received medical data from the input module, where the processing includes:
comparing the receive medical data to the unique classification rules, and based thereon;
extracting an appropriate personalized medical assessment indicator for the patient.

2. The clinical decision support system according to claim 1, wherein the interactive rules associated to the two or more different medical training data sources are governed by mathematical functions whereby the variable factors of the functions are the first and the at least one second weight factors.

3. The clinical decision support system according to claim 1, wherein the interactive rules associated to the two or more different medical training data sources are defined by a look-up table indicating how different values of the first and the at least one second weight factors result in different clinical weight factors.

4. The clinical decision support system according to claim 1, wherein the independent weight factors within the two or more different medical training data sources are within a pre-defined weight value range and where the severity of the objective findings within each data source is indicated by different values within the pre-defined weight value range.

5. The clinical decision support system according to claim 1, wherein the independent weight factors within the two or more different medical training data sources are defined by medical experts where the severity of the objective findings within each data source is indicated with values within the pre-defined weight value range.

6. The clinical decision support system according to claim 1, further comprising triggering, upon that the severity of the objective findings within a data source indicated by independent weight factors changes, a signal instructing the computer program to updated the knowledge mapping by means of repeating steps a)-c) so as to update the update the unique classification rules.

7. The clinical decision support system according to claim 1, wherein the unique classification rules are defined in at least one decision tree where the different branching in the decision tree indicate different clinical weight factors, wherein the step of comparing the receive medical data to the unique classification rules comprises positioning the patient within the at least one decision tree.

8. The clinical decision support system according to claim 7, wherein the associated weight value of the clinical weight factor where the patient is positioned within the at least one decision tree is utilized as input data in extracting the appropriate personalized medical assessment indicator for the patient.

9. The clinical decision support system according to claim 1, wherein the appropriate personalized medical assessment indicator is indicated in ascending order values where the higher the order is the more severe is the diagnosis of the disease.

10. The clinical decision support system according to claim 9, further comprising a display operated by the processor wherein the ascending order values are adapted to visually presenting the severity visually to the patient.

11. The clinical decision support system according to claim 10, wherein the personalized medical assessment indicator triggers at least one of the following recommendations:
diagnostic recommendation;
therapeutic medical recommendation;
therapeutic and preventive life-style recommendation;
follow up recommendation.

12. The clinical decision support system according to claim 1, wherein the receive medical data about the patient include the age of the patient, wherein the age is utilized in by the processor in triggering comparison process where the diagnosis of the patient is compared with the diagnosis of other patients of the same or similar age.

13. The clinical decision support system according to claim 1, wherein in case the personalized medical assessment indicator exceeds a pre-defined threshold level the processor instructs that patient via communication means to immediately seek for assistance by a medical expert.

14. A computerized diagnostic method for diagnosis and monitoring of a disease of at least one patient, the method comprising:
storing medical data sets from two or more different medical training data sources at a storage media in a computer system, where each of the two or more different medical training data sources have uniquely defined objective findings influencing the disease, the severity of the objective findings within each data source being indicated by independent weight factors;
performing, via a computer program operating on the computing system, a knowledge mapping between the data in the two or more different medical training data sources, where the knowledge mapping includes:
a) receiving a first and at least one second weight factors from a first and at least one second medical training data sources selected from the two or more different medical training data sources;
b) determining, based on the received weight factors, at least one clinical weight factor by means of utilizing interactive rules associated to the two or more different medical training data sources, the at least one clinical weight factor indicating the severity of the combination of the first and the at least one second symptom weight factors to the disease;
c) repeating steps a) and b) for the remaining weight factors within the two or more different medical training data sources so as to determine the remaining clinical weight factors resulting in a unique classification rules;
receiving, via an input module, medical data about a patient; and
processing, via a processor, the received medical data from the input module, where the processing includes:
comparing the receive medical data to the unique classification rules, and based thereon;
extracting an appropriate personalized medical assessment indicator for the patient.

15. A computer readable medium storing computer readable program code embodied therein for diagnosing and monitoring of a disease of at least one patient, the computer readable code comprising instructions which when executed by a processor perform the method of:
performing, via a computer program operating on a computing system, a knowledge mapping between data in two or more different medical training data sources stored;
a storage media in the computer system, where each of the two or more different medical training data sources have uniquely defined objective findings influencing the disease, the severity of the objective findings within each data source being indicated by independent weight factors, where the data where the knowledge mapping includes:
a) receiving a first and at least one second weight factors from a first and at least one second medical training data sources selected from the two or more different medical training data sources;
b) determining, based on the received weight factors, at least one clinical weight factor by means of utilizing interactive rules associated to the two or more different medical training data sources, the at least one clinical weight factor indicating the severity of the combination of the first and the at least one second symptom weight factors to the disease;
c) repeating steps a) and b) for the remaining weight factors within the two or more different medical training data sources so as to determine the remaining clinical weight factors resulting in a unique classification rules;
receiving, via an input module, medical data about a patient; and
processing, via a processor, the received medical data from the input module, where the processing includes:
comparing the receive medical data to the unique classification rules, and based thereon;
extracting an appropriate personalized medical assessment indicator for the patient.
